(19) United States
(12) Patent Application Publication
(10) Pub. No.: US 2019/0253211 A1
(43) Pub. Date: Aug. 15, 2019

(54) WIRELESS COMMUNICATION METHOD

(71) Applicants: NTT DOCOMO, INC., Tokyo (JP); DOCOMO INNOVATIONS, INC., Palo Alto, CA (US)

(72) Inventors: Yuichi Kakishima, Tokyo (JP); Chongning Na, Tokyo (JP); Satoshi Nagata, Tokyo (JP)

(73) Assignee: NTT DOCOMO, INC., Tokyo (JP)

(21) Appl. No.: 16/337,787

(22) PCT Filed: Sep. 28, 2017
(86) PCT No.: PCT/US2017/054138

§ 371 Date: Mar. 28, 2019

Related U.S. Application Data
(60) Provisional application No. 62/401,033, filed on Sep. 28, 2016.

(51) Int. Cl. H04L 5/00; H04B 7/06; H04L 1/00

(52) U.S. Cl. CPC H04L 5/0023; H04B 7/0695; H04B 7/0626; H04L 1/0026; H04B 7/0617; H04L 5/0048

(57) ABSTRACT

A wireless communication method includes transmitting, from a base station (BS) to a user equipment (UE), multiple reference signals (RSs) that are time-multiplexed. The multiple RSs are multiplexed at a same frequency position. The multiple RSs applies a common code. The method further includes transmitting, from the BS to the UE, resource information that indicates the common code. The method further includes notifying, with the BS, the UE, the number of transmission of the multiple RSs in a predetermined period. The multiple RSs are transmitted at successive intervals. The method further includes notifying, with the 135, the UE of each of the successive intervals.

### TECHNICAL FIELD

The present invention generally relates to a wireless communication method and, more particularly, to a method of transmission of reference signals (RSs) and resource selection using the RSs.

### BACKGROUND ART

Long Term Evolution (LTE) and LTE-Advanced (LTE-A) standards support full digital beamforming. Beamforming and precoding operation in the full digital beamforming is performed in a baseband digital circuit as shown in FIG. 1A.

Furthermore, for a higher carrier with a large frequency bandwidth such as New Radio (NR; fifth generation (5G) radio access technology), it may not be feasible to have a large number of digital-to-analogue converter (DAC) with a large sampling frequency. Thus, it may be efficient to perform beamforming in an analogue circuit as shown in FIG. 1B (analogue beamforming). The DAC is also referred to as TXRU (transceiver unit), etc. An analogue precoder consists of phase and amplitude controllers. The analogue precoder can operate as a switch.

In the Third Generation Partnership Project (3GPP), hybrid beamforming utilizing beamforming both in digital and analogue circuits as shown in FIG. 1C is being studied. The hybrid beam forming can achieve good trade-off between the digital and analogue beamforming. This makes it possible to perform the precoding operation efficiently for hybrid beamforming systems.

On the other hand, in general, methods for determining a precoding vector using downlink reference signals are classified as a method using a non-precoded (NP) Channel State Information-Reference Signal (CSI-RS) or a method using a beamformed (BF) CSI-RS.

According to the method using the NP CSI-RS, a base station (BS) transmits different reference signal sequences from multiple Tx antennas of the BS, and then a user equipment (UE) perform channel estimation based on the reference signal sequences and transmits CSI feedback to the BS. For example, the CSI feedback may include a Precoding Matrix Indicator (PMI). For example, the CSI feedback may include explicit channel information such as raw channel information, an eigenvector, and an eigenvalue.

According to the method using the BF CSI-RS, the BS transmits BF reference signals from the multiple Tx antennas of the BS, and then the UE estimate an effective channel after beamforming is applied and transmits the CSI feedback to the BS. For example, in the method using multiple BF CSI-RSs, the effective channel having the highest reception quality may be selected. For example, the UE may transmit the CSI feedback corresponding to the effective channel to the BS.

In the analogue beamforming including an analogue beamforming unit in the hybrid beamforming, it is assumed that the BF CSI-RS is used due to a configuration of the circuit. However, in the analogue beamforming operation, subband precoding cannot be performed; and therefore, it is required that beams are switched in a short period.

### CITATION LIST

### Non-Patent Reference

[Non-Patent Reference 1] 3GPP, TS 36.211 V 13.2.0

[Non-Patent Reference 2] 3GPP, TS 36.213 V 13.2.0

### SUMMARY OF THE INVENTION

According to one or more embodiments of the present invention, a wireless communication method includes transmitting, from a base station (BS) to a user equipment (UE), multiple reference signals (RSs) that are time-multiplexed. The multiple RSs may be multiplexed at a same frequency position and transmitting, from the UE to the BS, feedback information indicating the selected transmission resource.

According to one or more embodiments of the present invention, a wireless communication method includes selecting, with a user equipment (UE), at least a transmission resource from multiple transmission resources applied to multiple reference signals (RSs) transmitted from a base station (BS) based on reception quality of the multiple RSs.

According to one or more embodiments of the present invention, an analogue beam selection method may comprise beam sweeping, with a base station (BS), with multiple beams per Orthogonal Frequency Division Multiplexing (OFDM) symbol; and transmitting, from the BS to a user equipment (UE), reference signals (RSs) using the multiple beams.

### BRIEF DESCRIPTION OF THE DRAWINGS

FIGS. 1A, 1B, and 1C are diagrams showing circuits used for digital beamforming, analogue beamforming, and hybrid beamforming, respectively.

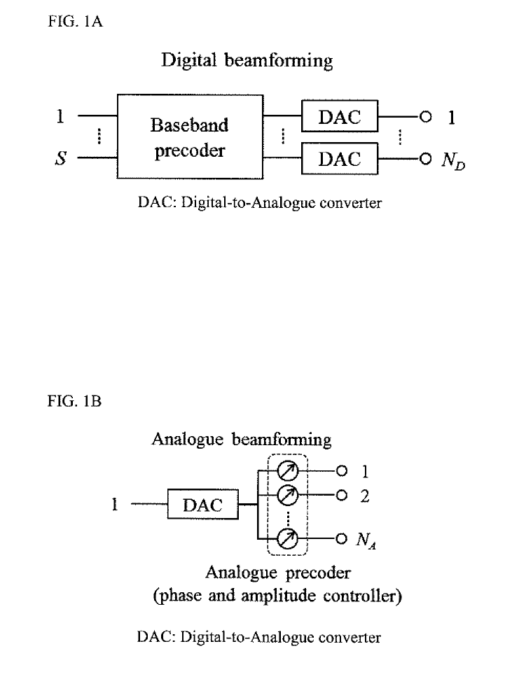

FIG. 2 is a diagram showing a configuration of a wireless communication system according to one or more embodiments of the present invention.

FIG. 3 is a diagram showing an antenna configuration in a BS according to one or more embodiments of the present invention.

FIG. 4 is a diagram showing a configuration of a circuit of the BS according to one or more embodiments of the present invention.

FIG. 5 is a diagram showing an analogue beam selection scheme according to one or more embodiments of a first example of the present invention.

FIG. 6 is a sequence diagram showing an example operation of CSI-RS transmission and CSI feedback based on the analogue beam selection scheme according to one or more embodiments of the first example of the present invention.

FIG. 7 is a diagram showing an example of a method for multiplexing beams in the analogue beam selection scheme according to one or more embodiments of a second example of the present invention.

FIG. 8 is a diagram showing another example of a method for multiplexing beams in the analogue beam selection scheme according to one or more embodiments of the second example of the present invention.

FIG. 9A is a diagram showing an example where the FDM is applied to the analogue beam and antenna ports according to one or more embodiments of the first and second examples of the present invention.

FIG. 9B is a diagram showing an example where the FDM and CDM are applied to the analogue beam and antenna ports according to one or more embodiments of the first and second examples of the present invention.

FIG. 9C is a diagram showing an example where the CDM is applied to multiple analogue beams and antenna ports according to one or more embodiments of the first and second examples of the present invention.

FIG. 9D is a diagram showing an example where the FDM and CDM are applied to multiple analogue beams and antenna ports according to one or more embodiments of the first and second examples of the present invention.

FIG. 10A is a sequence diagram showing an example operation of CSI-RS transmission and CSI feedback based on the analogue beam selection scheme according to one or more embodiments of another example of the first and second examples of the present invention.

FIG. 10B is a diagram showing an analogue beam selection scheme according to one or more embodiments of another example of the first and second examples of the present invention.

FIG. 11 is a diagram showing a configuration of a circuit of the BS according to one or more embodiments of another example of the second example of the present invention.

FIGS. 12A, 12B, 12C, and 12D are diagrams showing digital beam selection methods in the hybrid beamforming according to one or more embodiments of a third example of the present invention.

FIG. 13 is a diagram showing a table indicating an antenna panel associated with Tx timing of analogue beams according to one or more embodiments of a fourth example of the present invention.

FIG. 14 is a block diagram showing a schematic configuration of a base station according to one or more embodiments of the present invention.

FIG. 15 is a block diagram showing a schematic configuration of a user equipment according to one or more embodiments of the present invention.

### DETAILED DESCRIPTION OF EMBODIMENTS

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

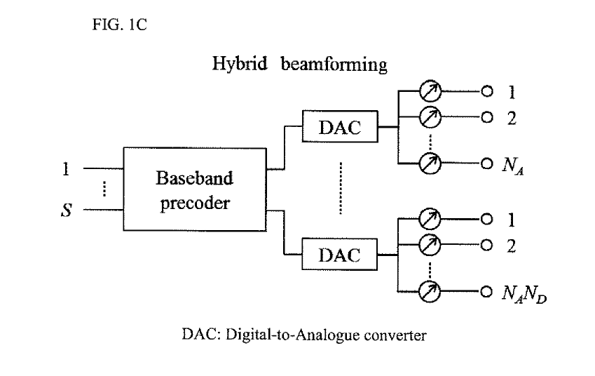

FIG. 2 illustrates a wireless communications system 1 according to one or more embodiments of the present invention. The wireless communication system 1 includes a user equipment (UE) 10, a base stations (BS) 20, and a core network 30. The wireless communication system 1 may be a New Radio (NR) system, an LTE/LTE-Advanced (LTE-A) system, or other systems. The wireless communication system 1 is not limited to the specific configurations described herein and may be any type of wireless communication system.

The BS 20 may communicate uplink (UL) and downlink (DL) signals with the UE 10 in a cell. The DL and UL signals may include control information and user data. The BS 20 may communicate DL and UL signals with the core network 30 through backhaul links 31. The BS 20 may be a gNodeB (gNB). The BS 20 may transmit multiple CSI-RSs to the UE 10 using multiple beams. In one or more embodiments of the present invention, the CSI-RS is an example of reference signal (RS). In one or more embodiments of the present invention, the beam is an example of resource.

The BS 20 includes antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

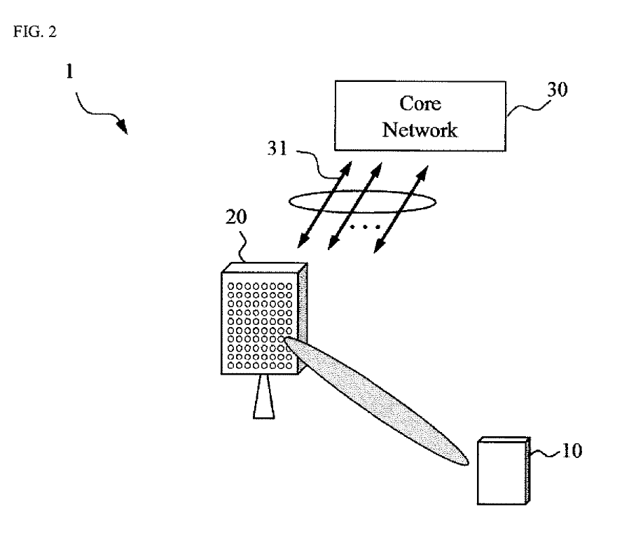

FIG. 3 is a diagram showing an antenna configuration in the BS 20 according to one or more embodiments of the present invention. As shown in FIG. 3, the BS 20 includes antenna element groups 201 consist of one or more orthogonal polarization antenna elements 2011. For example, an antenna panel corresponds to the antenna element group 201. For example, the antenna configuration may be defined as follows.

(M, N, P, Mg, Ng)=(the number of vertical elements per antenna panel, the number of horizontal elements per antenna panel, the number of polarization planes, the number of antenna panels in a vertical direction, the number of antenna panels in a horizontal direction)

A configuration of the antenna panel is not limited to a physical configuration of the antenna panel and may be a logical configuration of the antenna panel. Furthermore, the antenna element group 201 may be set so that the antenna element group 201 includes the antenna elements 2011 in a predetermined range.

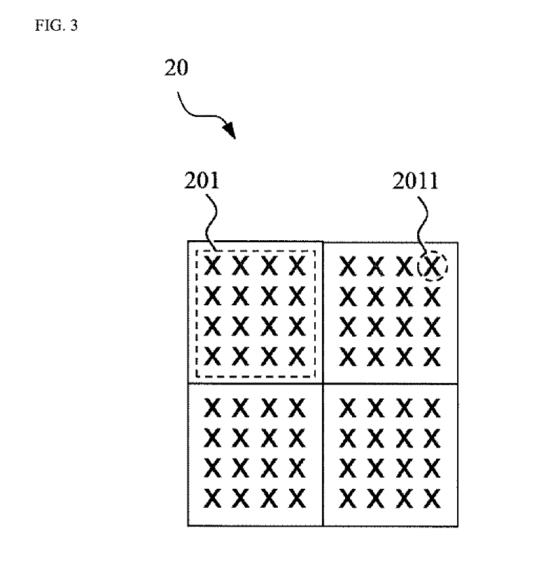

FIG. 4 is a diagram showing a configuration of a circuit of the BS 20 for hybrid beamforming according to one or more embodiments of the present invention. The circuit of the BS 20 includes a baseband precoder 2001, Digital-to-Analogue Converters (DACs) 2002, and analogue precoder 2003. In one or more embodiments of the present invention, the circuit of the BS 20 may include both features (configurations) of a digital circuit and an analogue circuit. The circuit of the BS 20 may be used for a hybrid beamforming operation by combining digital and analogue beamforming operations. One antenna element 2011 and a polarized wave may correspond to one DAC 2002. The analogue precoder 2003 comprise phase and amplitude controllers. Furthermore, the configuration of the antenna elements 2011 of the BS 20 is not limited to the above configuration and may be another configuration of the antenna elements 2011 and a configuration based on a virtualization method including full connection. Furthermore, although the antenna element groups 201 in FIG. 3 are adjacent to each other, the antenna element groups 201 may not be adjacent to each other.

### FIRST EXAMPLE

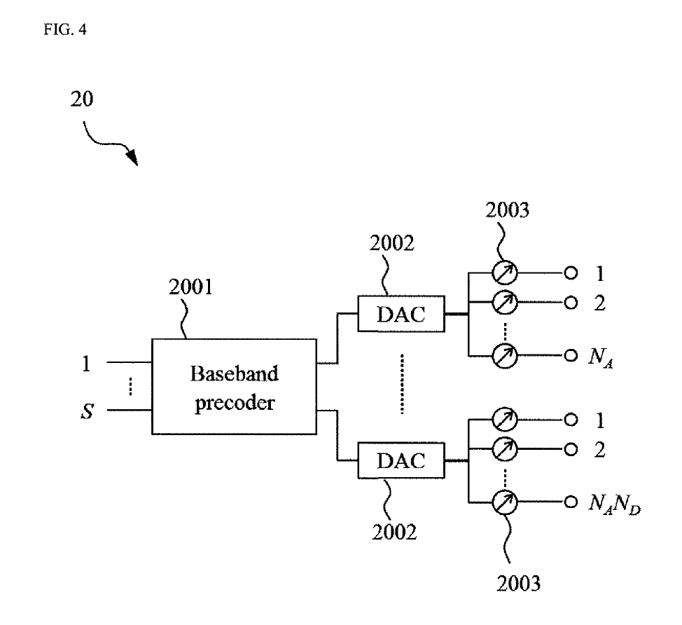

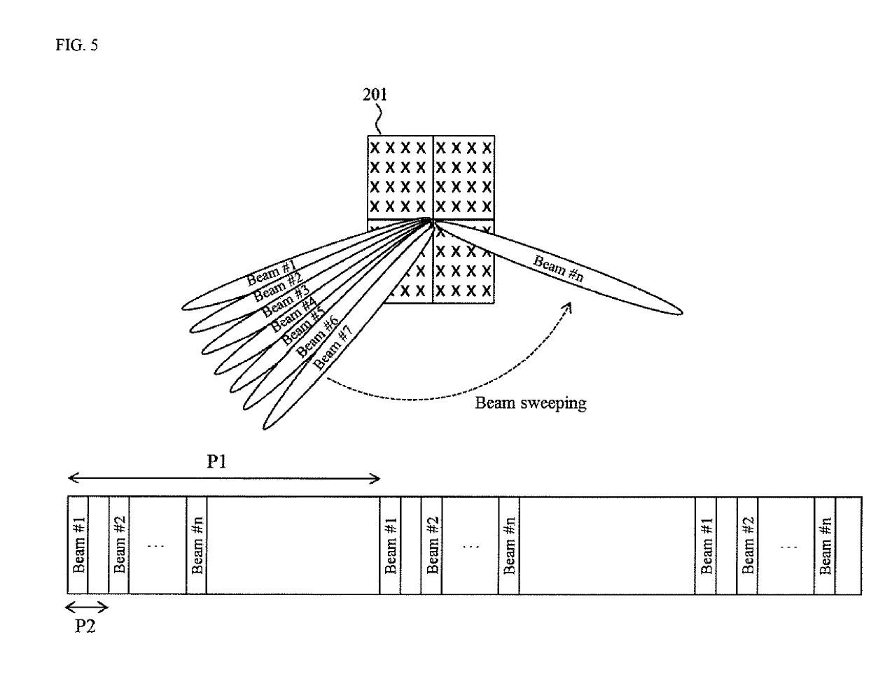

Embodiments of a first example of the present invention will be described below in detail with reference to FIGS. 5 and 6. When the BS 20 performs the analogue or analogue beamforming part in hybrid beamforming operation, it is required that beams are switched in a short period because the subband precoding cannot be performed in the analogue or analogue beamforming part in hybrid beamforming operation. According to one or more embodiments of the first example of the present invention, multiple CSI-RSs (beams) from the BS 20 may be time-multiplexed in the antenna of the BS 20 as an analogue beam selection scheme. For example, the multiple CSI-RSs may be multiplexed at the same frequency position. The multiple RSs (or CSI-RS ports) may be applied code-division-multiplexing using a common code.

For example, the BS 20 may transmit a single beam per unit time using all the antenna elements 2011. As shown in FIG. 5, each of multiple beams (e.g., beams #1, #2, . . . , #n) applied to each of multiple CSI-RSs (e.g., CSI-RSs #1, #2, . . . , #n) may be transmitted with interval P2 from all the antenna elements 2011. In other words, the BS 20 may perform beam sweeping with interval P2. The interval P2 is called unit time. The BS 20 may notify the UE 10 of the interval P2. In FIG. 5, a period P1 is a time range between a first beam #1 and a second beam #1, for example. Thus, the BS 20 may transmit multiple CSI-RSs (e.g., CSI-RSs #1, #2, . . . , #n) that are time-multiplexed in the period P1 using multiple beams (e.g., beams #1, #2, . . . , #n).

FIG. 6 is a sequence diagram showing an example operation of CSI-RS transmission and CSI feedback based on the analogue beam selection scheme according to one or more embodiments of the first example of the present invention.

As shown in FIG. 6, at step S101, the BS 20 may transmit resource information to the UE 10. For example, the resource information includes a temporal position of time-multiplexed CSI-RSs. For example, the resource information includes a frequency position of frequency-multiplexed CSI-RSs and a code used for code-division-multiplexing (CDM) CSI-RSs. For example, the resource information includes the number of transmission of the multiple CSI-RS in a predetermined period (e.g., period P1). For example, the resource information includes information that indicates an interval (e.g., interval P2) of transmission of the multiple CSI-RSs. Furthermore, the resource information includes information that indicates a time offset position in addition to the interval (e.g., interval P2). The resource information may be transmitted using at least one of a Master Information Block (MIB), a System Information Block (SIB), Radio Resource Control (RRC) signaling and lower layer signaling using MAC CE and/or Downlink Control Information (DCI).

Then, at step S102, the BS 20 may transmit multiple time-multiplexed CSI-RSs #1, #2, . . . , and #n using multiple beams (transmission resources) #1, #2, . . . , and #n, respectively.

At the step 5102, the multiple CSI-RSs #1, #2, . . . , and #n may be transmitted at successive intervals (e.g., intervals P2). For example, the interval of transmission between CSI-RS #1 and CSI-RS #2 may be the interval P2. The successive intervals may be an Orthogonal Frequency Division Multiplexing (OFDM) symbols or subframes.

At the step S102, the multiple CSI-RSs may be frequency-multiplexed at the same frequency position. In such a case, the resource information may indicate the same frequency position. The multiple CSI-RSs (or CSI-RS ports) may be code-division-multiplexed using a common code (the multiple RSs applies a common code). In such a case, the resource information may indicate the common code.

The UE 10 may receive the multiple CSI-RSs #1, #2, . . . , and #n to which the multiple beams #1, #2, . . . , and #n are applied, using the resource information. Then, the UE 10 may calculate reception quality (channel quality) (e.g., CSI derivation, RSRP derivation, etc.,) of the multiple CSI-RSs #1, #2, . . . , and #n. The UE 10 may select at least a beam (a resource) from the multiple beams (resources) #1, #2, . . . , and #n based on the reception quality. For example, a beam applied to the CSI-RS of which the reception quality is the best may be selected. For example, M beams applied to the CSI-RSs of which the reception quality is the best-M may be selected. As another example, the UE 10 may select the beam(s) from part of the multiple beams (e.g., beams #1, #3, #5).

At step S103, the UE 10 may transmit feedback information to the BS 20. The feedback information may indicate the selected beam(s) (transmission resources). The selected beam in the feedback information may be indicated as a beam index or a CSI-RS Resource Indicator (CRI). The feedback information includes reception quality (e.g., Reference Signal Received Power (RSRP), Received Signal Strength Indicator (RSSI), and Channel Quality Indicator (CQI)), Rank Indicator (RI), and Precoding Matrix Indicator (PMI) of the selected beam(s).

At step S104, when the BS 20 receives the feedback information, the BS 20 may transmit (precoded) downlink data to the UE 10.

Furthermore, according to one or more embodiments of the first example of the present invention, the CSI-RS transmission and CSI reporting may be triggered by the DCI. The trigger may be single for the reference signal transmission and the CSI reporting or independent between the reference signal transmission and the CSI reporting.

According to one or more embodiments of the first example of the present invention, when the BS 20 acquires beam information (e.g., rough CSI) in advance, the BS 20 may not transmit a part of beams. The number of transmitted beam from the BS 20 may be switched.

According to one or more embodiments of the first example of the present invention, the BS 20 may transmit, to the UE 10, beam information indicating the beam(s) (transmission resource(s)) applied to the multiple CSI-RSs. For example, the beam information may indicate whether an identical beam is applied to the multiple RSs. For example, the resource information may include the beam information. As another example, the beam information may be transmitted separately from the resource information.

According to one or more embodiments of the first example of the present invention, the BS 20 may transmit, to the UE 10, beam information indicating whether the UE 10 can receive the multiple CSI-RSs using an identical beam used for reception in the UE 10 (reception resource).

These assumptions for beam may be indicated as quasi co-location (QCL) information or spatial QCL information. Those information may imply (spatial) QCL information at transmitter side or receiver side.

According to one or more embodiments of the first example of the present invention, the BS 20 may notify the UE 10 of information indicating whether an identical spatial QCL can be applied to the multiple CSI-RSs.

According to one or more embodiments of the first example of the present invention, the BS 20 may notify the UE 10 of information indicating whether the UE can receive the multiple CSI-RSs assuming that an identical spatial QCL is applied to the multiple CSI-RSs.

According to one or more embodiments of the first example of the present invention, the UE 10 may assume that the resource information indicating the position where the CSI-RSs are frequency-division-multiplexed and information regarding the CDM are the same information can be applied to the multiple CSI-RS resources which are time-division-multiplexed.

According to one or more embodiments of the first example of the present invention, the CSI-RSs may be transmitted from either of the polarization antennas. Thus, the BS 20 may transmit the multiple CSI-RSs using one antenna port or two antenna ports. As another example, the CSI-RSs may be transmitted from both of the polarization antennas.

According to one or more embodiments of the first example of the present invention, the UE 10 may select at least one beam based on a reception result of the multiple beams from the BS 20 and then transmit the CSI feedback to the BS 20. For example, the CSI feedback may include a Beam Index (BI) (or CRI). Furthermore, the CSI feedback may include reception quality of the reference signal corresponding to the selected beam.

### SECOND EXAMPLE

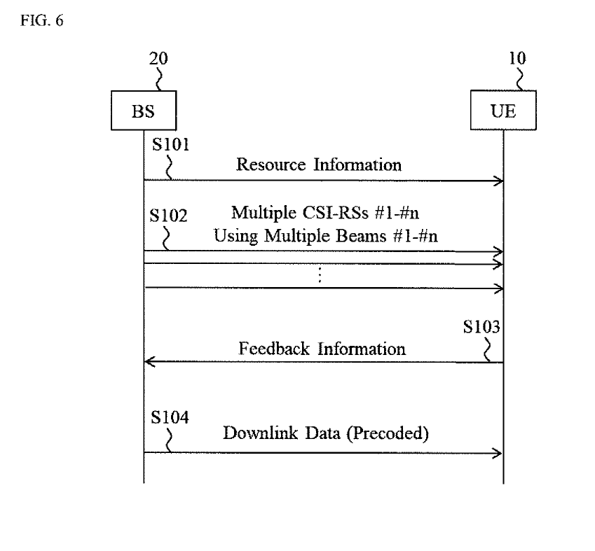

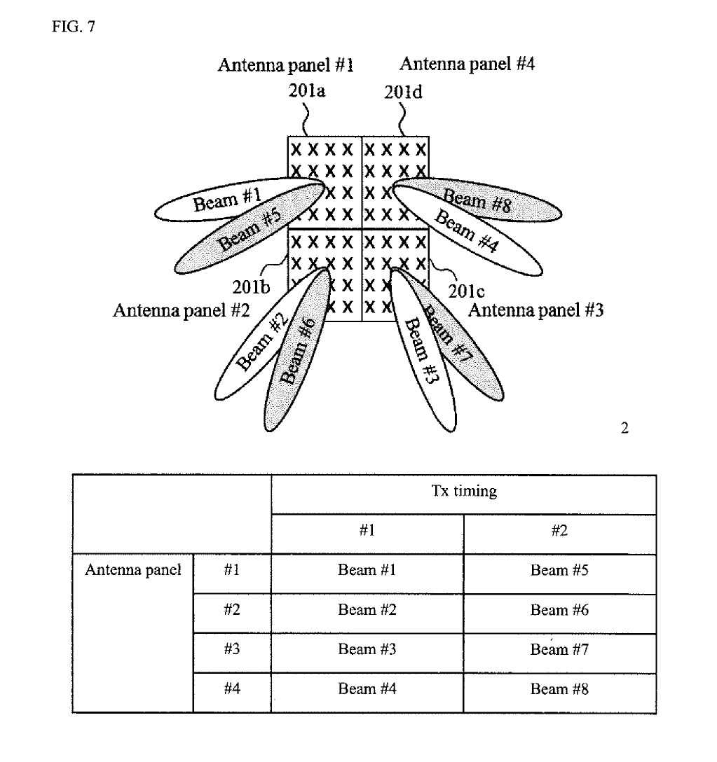

Embodiments of a second example of the present invention will be described below in detail with reference to FIGS. 7 and 8. According to one or more embodiments of the second example of the present invention, the BS 20 may transmit multiple analogue beams in a predetermined transmission period (e.g., OFDM symbol) from the antenna. This makes it possible to reduce time for the beam sweeping. Furthermore, it may be possible to reduce the number of beams for the beam sweeping because beam width increases by transmitting multiple beams simultaneously. The method according to one or more embodiments of the second example of the present invention may be applied to the method according to one or more embodiments of the first example of the present invention.

According to one or more embodiments of the second example of the present invention, for example, as shown in FIG. 7, the BS 20 may generate different beams for each antenna panel (antenna element group 201). In FIG. 7, the antenna element groups 201a, 201b, 201c, and 201d correspond to the antenna panels #1, #2, #3, and #4, respectively. The beams #1 and #5 may be transmitted from the antenna panel #1 (antenna element group 201a). The beams #2 and #6 may be transmitted from the antenna panel #2 (antenna element group 201b). The beams #3 and #7 may be transmitted from the antenna panel #3 (antenna element group 201c). The beams #4 and #8 may be transmitted from the antenna panel #4 (antenna element group 201d). Furthermore, in FIG. 7, the beams #1, #2, #3, and #4 may be transmitted at Tx timing #1 and the beams #5, #6, #7, and #8 may be transmitted at Tx timing #2.

In an example of FIG. 7, when the multiple beams (e.g., beams #1 and #5) are transmitted from the same antenna panel (e.g., antenna panel #1), the multiple beams pass through the same physical propagation path. On the other hand, in FIG. 7, the multiple beams (e.g., beams #1 and #2) are transmitted from the different antenna panels (e.g., antenna panels #1 and #2), the multiple beams pass through the different physical propagation paths. Therefore, in one or more embodiments of the second example of the present invention, the UE 10 may perform reception processing (e.g., time/frequency synchronization processing and averaging processing of a result of the channel estimation) in accordance with the physical propagation path. For example, the BS 20 may notify the UE 10 of information indicating whether the different beams pass through the same physical propagation path or not using higher or lower layer signaling. For example, the information of the propagation path may be notified as Quasi co-location information for each antenna panel (antenna element group 201).

On the other hand, even if the multiple beams pass through the same physical propagation path, it may be required that the UE 10 performs the different reception processing in accordance with whether the identical precoder is applied to the multiple beams. Therefore, the BS 20 may notify the UE 10 of whether the identical precoder is applied to the multiple beams. For example, information indicating whether the identical precoder is applied to the multiple beams may be transmitted as measurement restriction information from the UE 10 to the BS 20. For example, the information indicating whether the identical precoder is applied to the multiple beams may be transmitted for each antenna panel (antenna element group 201).

As another example of embodiments of the second example of the present invention, the BS 20 may apply spatial multiplexing to the multiple beams using multiple antenna panels (antenna panel groups 201). As shown in FIG. 8, the multiple beams from a predetermined antenna element group 201 may be special-multiplexed.

According to one or more embodiments of the second example of the present invention, the reference signals such as the CSI-RSs transmitted using the multiple beams may be time-multiplexed by applying Frequency Division Multiplexing (FDM) or CDM. In one or more embodiments of the present invention, comb based FDM is not precluded.

In one or more embodiments of the second example of the present invention, it may not be required that signal sequences of the multiple beams are completely orthogonal because the reference signals may be beamformed, as described above. For example, the BS 20 may cause signal sequences of the multiple beams transmitted in the predetermined transmission period to be non-orthogonal or quasi-orthogonal and then transmit the multiple beams. For example, the BS 20 may cause the reference signals to be non-orthogonal multiplexed. In other words, non-orthogonal sequences may be applied to the CSI-RS, a Synchronization Signal (SS), a Beam-specific Reference Signal (BRS), a Mobility RS (MRS), and a Measurement Reference Signal (MRS). Furthermore, a scrambling sequence may be applied to the CSI-RS, the SS, the BRS, and the MRS. For example, the scrambling sequence applied to the CSI-RS, the SS, the BRS, and the MRS may be identical to a scrambling sequence applied to a Demodulation Reference Signal (DM-RS).

According to one or more embodiments of the second example of the present invention, the beam having high space separation degree may be selected from the multiple beams simultaneously transmitted from the BS 20.

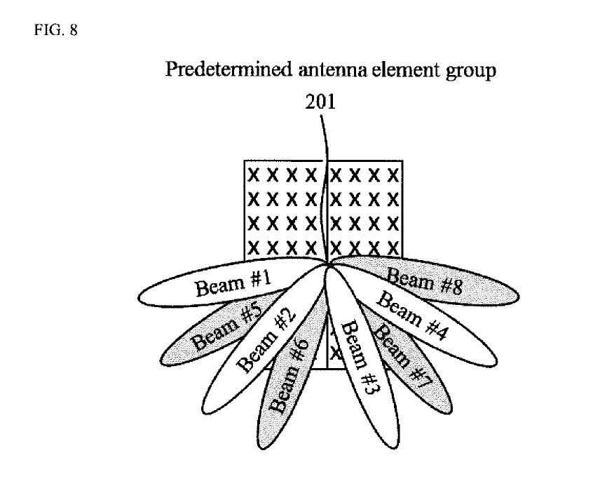

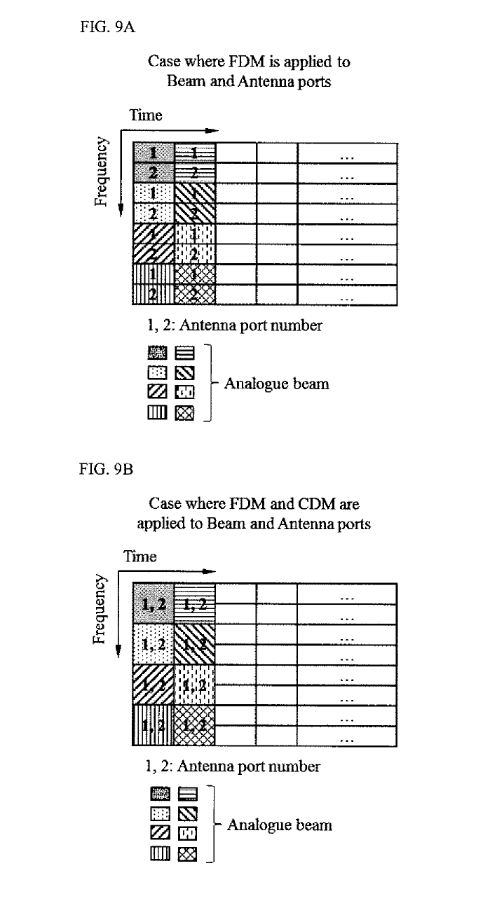

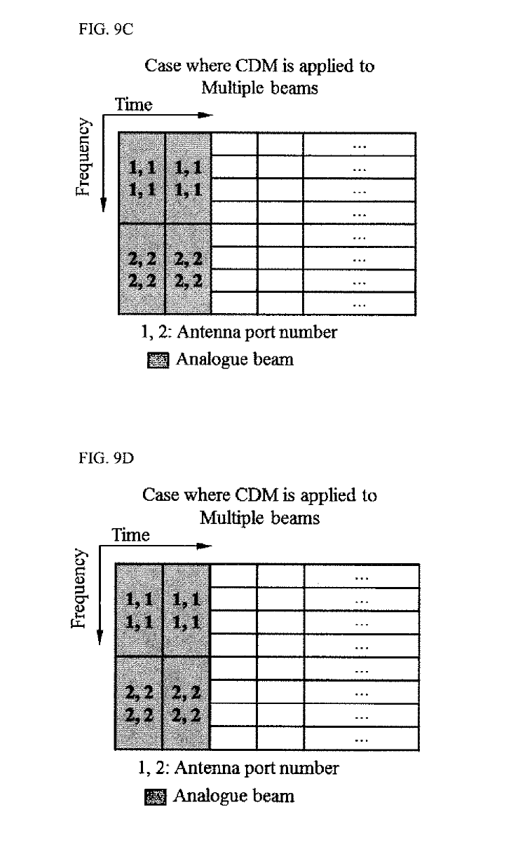

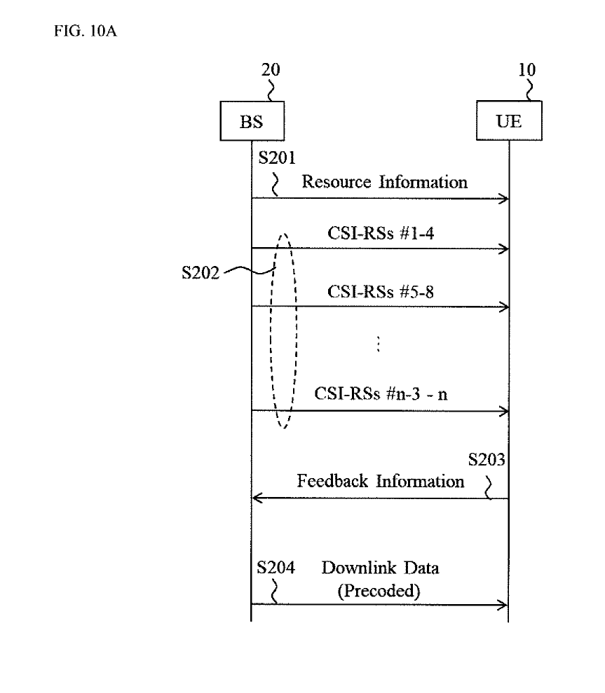

Examples of multiplexed beams and antenna ports in one or more embodiments of the first and second examples of the present invention will be described below with reference to FIGS. 9A-9D. As shown in FIGS. 9A-9D, one axis designates a frequency domain and the other axis designates a time domain. In FIGS. 9A-9D, “1” and “2” indicate the antenna port number and the hatched blocks indicate analogue beams. Although the number of antenna ports per beam in examples of FIGS. 9A-9D is “2,” the number of antenna ports per beam is predetermined value other than “2.”

FIG. 9A is a diagram showing an example where the FDM is applied to the analogue beam and antenna ports. FIG. 9B is a diagram showing an example where the FDM and CDM are applied to the analogue beam and antenna ports. FIG. 9C is a diagram showing an example where the CDM is applied to multiple analogue beams and antenna ports. FIG. 9D is a diagram showing an example where the FDM and CDM are applied to multiple analogue beams and antenna ports.

### ANOTHER EXAMPLE

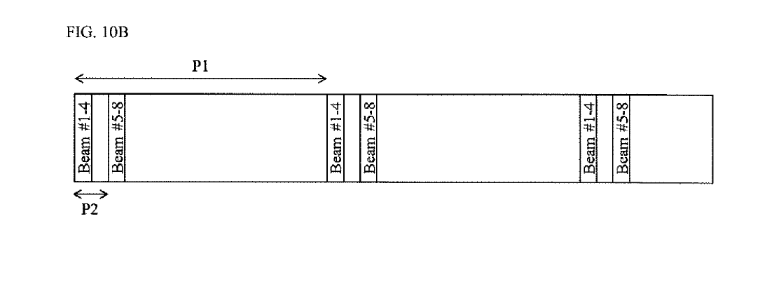

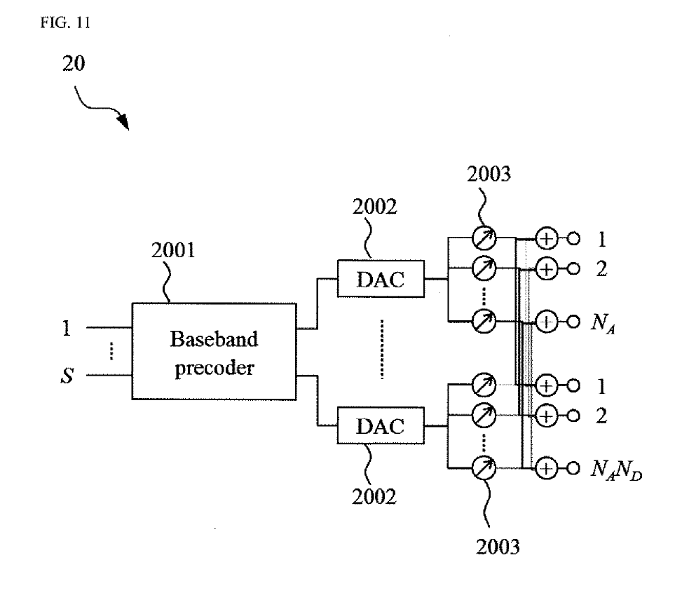

Embodiments of another example of the first and second examples of the present invention will be described below, with reference to FIGS. 10A and 10B. According to one or more embodiments of another example of the first and second examples of the present invention, the BS 20 may transmit multiple beams per unit time using the antenna elements 2011. As shown in FIGS. 10A and 10B, at step S201, the BS 20 may transmit the resource information to the UE 10. The resource information in FIG. 10 A may be similar to the resource information in FIG. 6. At step S202, the BS 20 may transmit a group of multiple BF CSI-RSs (e.g., CSI-RSs #1-#4) in unit time (interval P2). Then, the BS 20 may transmit CSI-RSs #5-#8 in the interval P2, . . . , and CSI-RSs #n-3-#n in the interval P2. The UE 10 may transmit, to the BS 20, the feedback information based on a result of the reception quality of the CSI-RSs, (step S202). At step S204, when the BS 20 receives the feedback information, the BS 20 may transmit (precoded) downlink data to the UE 10. As a result, this makes it possible to reduce time for the beam sweeping because multiple CSI-RSs are simultaneously transmitted in unit time.

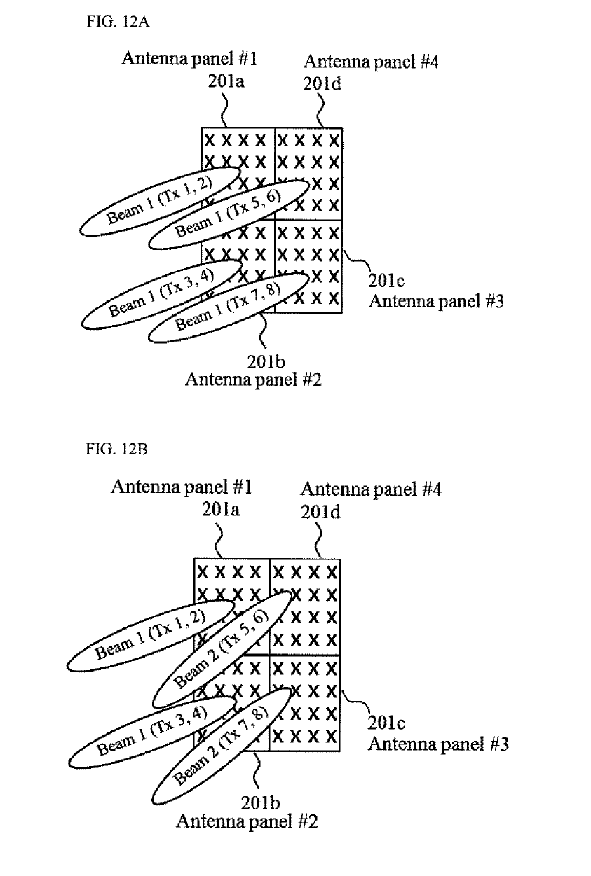

Another example of a configuration of a circuit of the BS 20 used for the hybrid beamforming will be described below with reference to FIG. 11. According to another example of the configuration of the circuit for the hybrid beamforming, as shown in FIG. 11, a plurality of DACs 2002 may input signals into a single antenna element 2011. In other words, output from a single DAC 2002 may be mapped to the all antenna elements 2011. According to the configuration in FIG. 11, it may be possible to generate multiple sharpened beams with high gain in unit time because a TXRU is mapped to more antenna elements 2011. The above technologies according to one or more embodiments of the second example of the present invention may be applied to the configuration of the circuit in FIG. 11.

### THIRD EXAMPLE

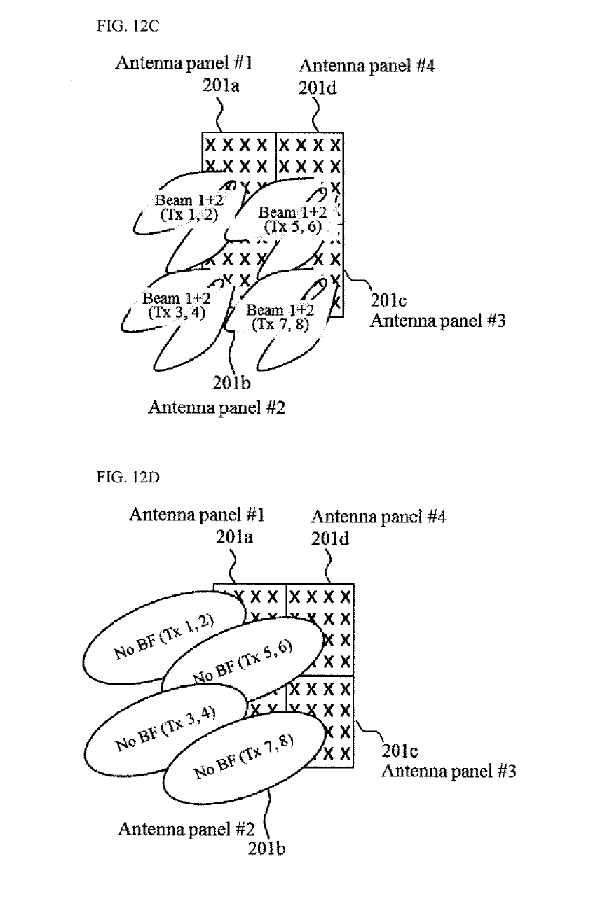

Embodiments of a third example of the present invention will be described below in detail with reference to FIGS. 12A-12D. It is impossible to apply only the digital beamforming scheme to the hybrid beamforming scheme due to the equipment configuration. Therefore, phase (and/or amplitude) fluctuations in the analogue circuit may be required.

According to one or more embodiments of the third example of the present invention, as shown in FIG. 12A, an identical analogue beam (Beam #1) may be applied to multiple different antenna panels (antenna panels #1-#4) (or antenna ports). Thus, the BS 20 may transmit the identical analogue beam from the different antenna panels (antenna ports).

As another example, as shown in FIG. 12B, different analogue beams (Beam #1-#4) may be applied to multiple different antenna panels (antenna panels #1-#4) (or antenna ports). Thus, the BS 20 may transmit the different analogue beams from the different antenna panels (antenna ports).

In the above methods in FIGS. 12A and 12B, the CSI feedback in response to the 8-Tx CSI-RSs may be performed. That is, the UE 10 may transmit the CSI feedback reports corresponding to the all antenna ports. This makes it possible to reduce the size of the CSI feedback reports.

As another example of the CSI feedback scheme in the above methods in FIGS. 12A and 12B, the CSI feedback in response to each of the analogue beams may be performed. For example, the CSI feedback in response to each of the Tx 1-4, 5-8 CSI-RSs may be performed. That is, the UE 10 may transmit the one or more CSI feedback reports in response to part of antenna ports or perform beam management. This makes it possible to reduce the size of the CSI feedback reports.

The CSI feedback schemes in the above methods in FIGS. 12A and 12B may be switched.

According to one or more embodiments of another example of the third example of the present invention, as shown in FIG. 12C, the multiple analogue beams (Beam #1 and #2) may be transmitted from each antenna panel (or antenna port).

According to one or more embodiments of another example of the third example of the present invention, as shown in FIG. 12D, the phase fluctuations may be applied so that the analogue circuit does not have directivity (the beamforming is used for making wide beams).

Information indicating the above schemes in FIGS. 12A-12D may be notified to the UE 10.

### FOURTH EXAMPLE

### Joint Selection of Analogue and Digital Beams in Hybrid Beamforming

The analogue and digital beam selection methods according to one or more embodiments of the first to third examples of the present invention may be combined with each other.

According to one or more embodiments of a fourth example of the present invention, beams may be determined step by step. For example, the analogue beam may be determined and then the digital beam may be determined. For example, the digital beam may be determined and then the analogue beam may be determined.

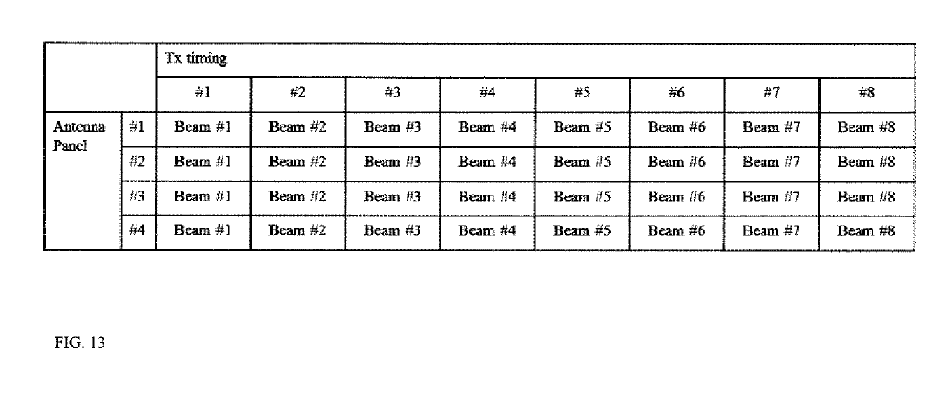

According to one or more embodiments of the fourth example of the present invention, both of the analogue and digital beams may be determined simultaneously. For example, the analogue beams may be switched based on a table indicating the antenna panel number associated with the Tx timing of the analogue beam as shown in FIG. 13. For example, the UE 10 may transmit information indicating the appropriate beam selected based on the reception result of the analogue beam and the CSI feedback reports related to the selected beam.

### Configuration of Base Station

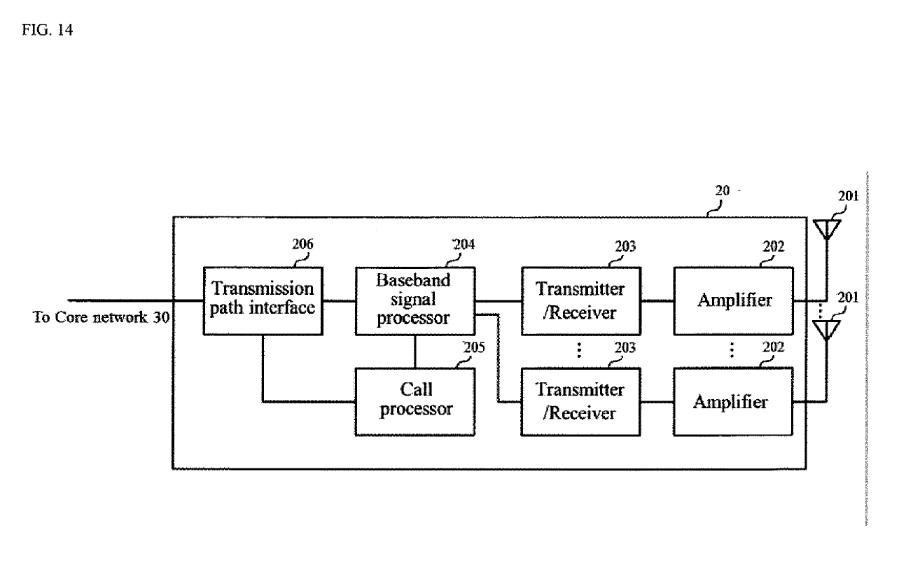

The BS 20 according to one or more embodiments of the present invention will be described below with reference to FIG. 14. FIG. 14 is a diagram illustrating a schematic configuration of the BS 20 according to one or more embodiments of the present invention. The BS 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the BS 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., RRC signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the BS 20, radio frequency signals are received in each antenna 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the BS 20, and manages the radio resources.

### Configuration of User Equipment

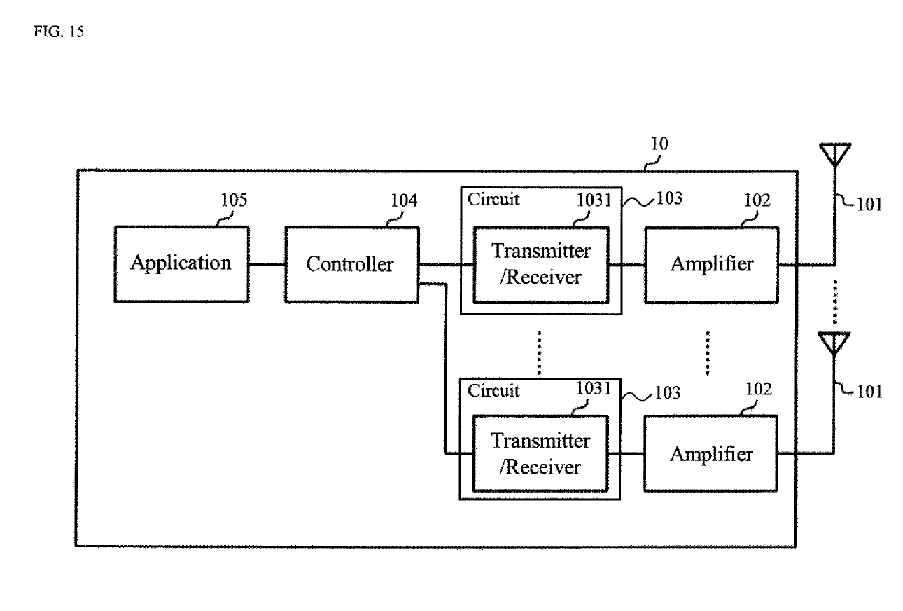

The UE 10 according to one or more embodiments of the present invention will be described below with reference to FIG. 15. FIG. 15 is a schematic configuration of the UE 10 according to one or more embodiments of the present invention. The UE 10 has a plurality of UE antennas 101, amplifiers 102, the circuit 103 comprising transceiver (transmitter/receiver) 1031, the controller 104, and an application 105.

As for DL, radio frequency signals received in the UE antennas 101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

One or more embodiments of the present invention may be used for each of the uplink and the downlink independently. One or more embodiments of the present invention may be also used for both of the uplink and the downlink in common.

Although the present disclosure mainly described examples of a channel and signaling scheme based on LTE/LTE-A, the present invention is not limited thereto. One or more embodiments of the present invention may apply to another channel and signaling scheme having the same functions as LTE/LTE-A, New Radio (NR), and a newly defined channel and signaling scheme.

Although the present disclosure mainly described examples of channel estimation and CSI feedback scheme based on the CSI-RS, the present invention is not limited thereto. One or more embodiments of the present invention may apply to another synchronization signal, reference signal, and physical channel such as synchronization signal (SS), measurement RS (MRS), mobility RS (MRS), and beam RS (BRS).

Although the present disclosure described examples of the beamformed CSI-RS, the beamformed CSI-RS in the present disclosure may be replaced with the CSI-RS, CSI-RS resource CSI-RS resource sets.

Although the present disclosure mainly described examples of various precoding methods based on the digital beamforming and analogue beamforming, one or more embodiments of the present invention may be applied regardless of digital beamforming and analogue beamforming.

Although the present disclosure mainly described examples of various signaling methods, the signaling according to one or more embodiments of the present invention may be the higher layer signaling such as the RRC signaling and/or the lower layer signaling such as the DCI. Furthermore, the signaling according to one or more embodiments of the present invention may use MIB, SIB and/or the Media Access Control (MAC) control element.

Although the present disclosure mainly described examples of various signaling methods, the signaling according to one or more embodiments of the present invention may be explicitly or implicitly performed.

Although the present disclosure mainly described examples of the UE including planer antennas, the present invention is not limited thereto. One or more embodiments of the present invention may also apply to the UE including one dimensional antennas and predetermined three dimensional antennas.

In one or more embodiments of the present invention, the resource block (RB) and a subcarrier in the present disclosure may be replaced with each other. A subframe and a symbol may be replaced with each other.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### EXPLANATION OF REFERENCES

1 Wireless communication system

10 User equipment (UE)

101 Antenna

102 Amplifier

103 Circuit

1031 Transceiver (transmitter/receiver)

104 Controller

105 Application

106 Switch

20 Base station (BS)

2001 Baseband precoder

2002 Digital-to-Analogue Converter (DAC)

2003 Analog precoder (phase and amplitude controller)

201 Antenna element group (Antenna)

2011 Antenna element

202 Amplifier

203 Transceiver (transmitter/receiver)

204 Baseband signal processor

205 Call processor

206 Transmission path interface

What is claimed is:

1. A wireless communication method comprising:
transmitting, from a base station (BS) to a user equipment (UE), multiple reference signals (RSs) that are time-multiplexed,
wherein the multiple RSs are multiplexed at a same frequency position.

2. The wireless communication method according to claim 1, wherein the multiple RSs applies a common code.

3. The wireless communication method according to claim 1, further comprising:
transmitting, from the BS to the UE, resource information that indicates the frequency position.

4. The wireless communication method according to claim 2, further comprising:
transmitting, from the BS to the UE, resource information that indicates the common code.

5. The wireless communication method according to claim 1, further comprising:
notifying, with the BS, the UE, a number of transmission of the multiple RSs in a predetermined period.

6. The wireless communication method according to claim 1, wherein the transmitting transmits the multiple RSs at successive intervals.

7. The wireless communication method according to claim 6, further comprising:
notifying, with the BS, the UE of each of the successive intervals.

8. The wireless communication method according to claim 7, wherein the notifying further notifies a time offset position.

9. The wireless communication method according to claim 1, wherein the transmitting transmits the multiple RSs using one antenna port or two antenna ports.

10. The wireless communication method according to claim 1,
wherein the transmitting transmits the multiple RSs using multiple transmission resources,
the wireless communication method further comprising:
selecting, with the UE, a transmission resource from part of the multiple transmission resources.

11. The wireless communication method according to claim 1, further comprising:
notifying, with the BS, the UE of spatial Quasi co-location information for the multiple RSs.

12. The wireless communication method according to claim 1, further comprising:
notifying, with the BS, the UE of information indicating spatial QCL information for the multiple RSs.

13. The wireless communication method according to claim 1, further comprising:
notifying, with the BS, the UE of information indicating whether an identical spatial QCL can be applied to the multiple RSs.

14. The wireless communication method according to claim 1, further comprising:
notifying, with the BS, the UE of information indicating whether the UE can receive the multiple RSs assuming an identical spatial QCL.

15. The wireless communication method according to claim 1, further comprising:
wherein the transmitting transmits the multiple RSs using multiple transmission resources,
the wireless communication method further comprising:
selecting, with the UE, at least a transmission resource from the multiple transmission resources based on the multiple RSs, and
transmitting, from the UE to the BS, feedback information indicating the selected transmission resource.

16. The wireless communication method according to claim 1, further comprising:
wherein the transmitting transmits the multiple RSs using multiple transmission resources,
the wireless communication method further comprising:
selecting, with the UE, at least a transmission resource from the multiple transmission resources based on the multiple RSs, and
transmitting, from the UE to the BS, feedback information indicating the selected transmission resource.

17. The wireless communication method according to claim 16, wherein the feedback information including a beam index or a Channel State Information (CSI)-RS Resource Indicator (CRI) corresponding to the selected beam.

18. The wireless communication method according to claim 16, wherein the feedback information including reception quality of the selected resource.

19. A wireless communication method comprising:
selecting, with a user equipment (UE), at least a transmission resource from multiple transmission resources applied to multiple reference signals (RSs) transmitted from a base station (BS) based on reception quality of the multiple RSs; and
transmitting, from the UE to the BS, feedback information indicating the selected transmission resource.

20. The wireless communication method according to claim 19, wherein the feedback information including a beam index or a Channel State Information (CSI)-RS Resource Indicator (CRI) corresponding to the selected beam.
